(19) United States
(12) Patent Application Publication
(10) Pub. No.: US 2016/0119195 A1
(43) Pub. Date: Apr. 28, 2016

(54) COMPUTING SERVICE LEVEL RISK

(71) Applicant: International Business Machines Corporation, Armonk, NY (US)

(72) Inventors: Randall W. Blondeau, Niwot, CO (US); Nadeem Malik, Austin, TX (US); David M. Northcutt, Chester, NJ (US); George E. Stark, Austin, TX (US)

(21) Appl. No.: 14/521,999

(22) Filed: Oct. 23, 2014

(51) Int. Cl. H04L 12/24

(52) U.S. Cl. CPC H04L 41/5025; H04L 41/5009; H04L 41/5029

(57) ABSTRACT

Statistical process control, performance distribution identification, and a simulation model based on, for example, Monte Carlo simulation, are used to calculate the risk of various service levels. A recommended service level is determined, the service level being one that is estimated to have an appropriate risk for both the outsourcing supplier and the customer.

### BACKGROUND OF THE INVENTION

The present invention relates generally to the field of service level agreements (SLA), and more particularly to computing service level risk.

In general, a service level agreement is a monetary, legal contract that specifies the minimum expectations and obligations that exist between a service recipient and a service provider. That is, an SLA defines the level of performance committed to the customer by the supplier. If performance expectations are not met, penalties may be paid to the customer.

Process capability, as discussed herein, refers to the range of values that a key performance indictor (KPI) may have based on a statistical process control analysis with respect to a rating from a commonly accepted process assessment model.

A statistical distribution, also referred to as a probability distribution, is a description of the relative number of times each possible outcome will occur in a given number of trials. The probability density function describes the probability that a given result will occur.

A statistical model is a formalization of relationships between variables in the form of mathematical equations. Essentially, a statistical model is a collection of statistical distributions. The Monte Carlo method is a method that solves a problem by generating suitable random numbers and observing that fraction of those numbers that obey some pre-determined property or properties.

### SUMMARY

According to an aspect of the present invention, there is a method, computer program product and/or system for determining a service level agreement (SLA) recommendation that performs the following steps (not necessarily in the following order): identifying a process capability by applying a statistical process control method to a past performance dataset, identifying a statistical distribution according to the past performance dataset, running a simulation model to determine a risk of missing a service level target based, at least in part, on the process capability and the statistical distribution, and recommending an SLA based, at least in part, on the risk of missing the service level target.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (for example, software) portion of the first embodiment system; and

FIG. 4 is a screenshot view generated by the first embodiment system.

### DETAILED DESCRIPTION

Statistical process control, performance distribution identification, and a simulation model based on, for example, Monte Carlo simulation, are used to calculate the risk of various service levels. A recommended service level is determined, the service level being one that is estimated to have an appropriate risk for both the outsourcing supplier and the customer.

This Detailed Description section is divided into the following sub-sections: (i) The Hardware and Software Environment; (ii) Example Embodiments and/or Comments; and (iii) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

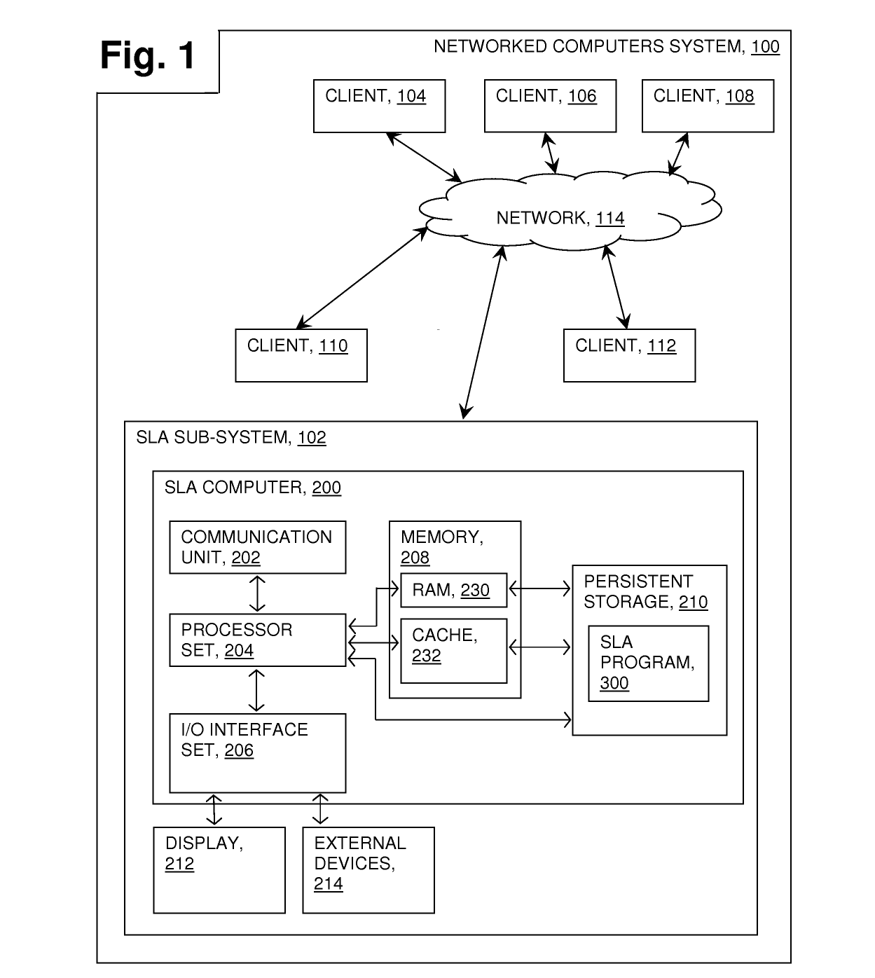

An embodiment of a possible hardware and software environment for software and/or methods according to the present invention will now be described in detail with reference to the Figures. FIG. 1 is a functional block diagram illustrating various portions of networked computers system 100, including: service level agreement (SLA) sub-system 102; client sub-systems 104, 106, 108, 110, 112; communication network 114; SLA computer 200; communication unit 202; processor set 204; input/output (I/O) interface set 206; memory device 208; persistent storage device 210; display device 212; external device set 214; random access memory (RAM) devices 230; cache memory device 232; and SLA recommendation program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with SLA computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### II. EXAMPLE EMBODIMENTS AND/OR COMMENTS

Some embodiments of the present invention recognize the following facts, potential problems and/or potential areas for improvement with respect to the current state of the art: (i) service level commitments are often established without understanding the risk of failure; (ii) conventionally, the risk of missing a defined service level commitment during operations is not calculated; (iii) the risk is not calculated because the necessary data is incomplete for determining risk; (iv) conventional models are inaccurate; (v) performance distribution is not identified; (vi) reporting is on processes during operations, not prior to the performance of operations; (vii) there is no defined risk measurement approach; (viii) failure to understand risk oftentimes results in poor client satisfaction; and/or (ix) failure to understand risk oftentimes results in payment of penalties (when poorly set targets are repeatedly missed).

Some embodiments of the present invention determine the probability that a given service level agreement (SLA) recommendation will achieve an SLA target (as defined within the SLA contract) based on the historical data of a client and the environment in which the client wants the SLA to be met. This embodiment estimates the monetary penalties that a supplier could pay to a client over the life of the SLA contract. Alternatively, non-monetary penalties are considered, such as reduced service term, performance of additional services, etc. Some embodiments of the present invention use the Monte Carlo method, performance distribution identification, and statistical process control in conjunction with one another. Alternatively, random sampling algorithms, other than Monte Carlo methods are used.

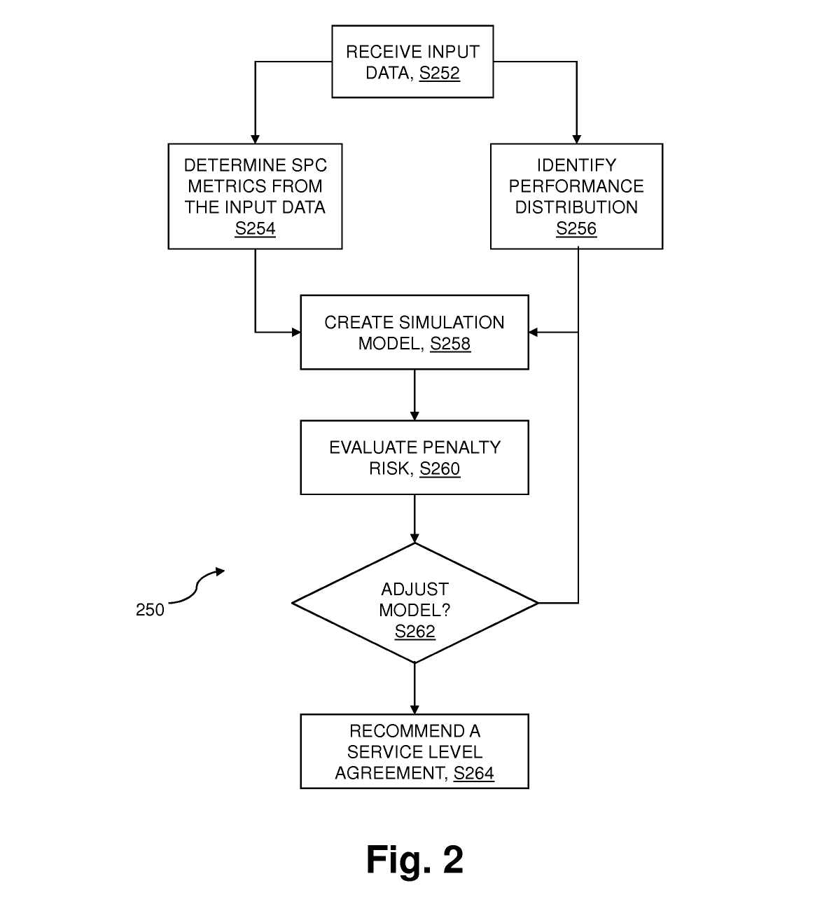

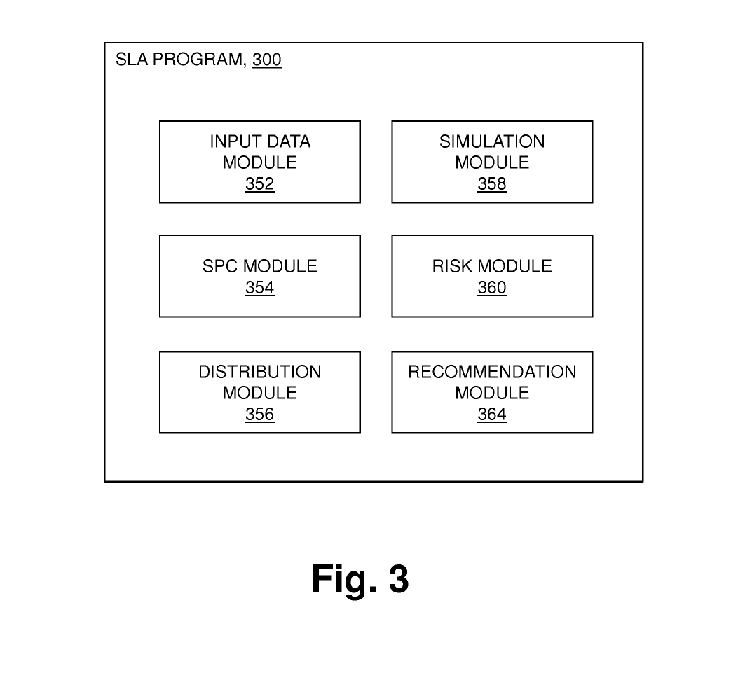

FIG. 2 is a flowchart depicting process 250 in accordance with an embodiment of the present invention. FIG. 3 shows program 300 for performing at least some of the process steps of flowchart 250. This process and associated software will now be discussed with extensive reference to FIG. 2 (for the process step blocks) and FIG. 3 (for the software blocks).

Processing begins with step S252, where input data module 352 receives input data for processing. Input data, also referred to herein as historical data, may include, but is not limited to: (i) workload; (ii) SLA target; (iii) penalty payment; (iv) performance. In this example, input data is received by human user input. Alternatively, input data is received by computer program. Alternatively, the input data module retrieves input data from an input data store(s). In this example, the input data is collected from a previous SLA with the same client. Alternatively, input data may include data from similar environments/processes to the one for which an SLA is being negotiated.

Processing proceeds to step S254, where statistical process control (SPC) module 354 determines SPC metrics based on the received input data. The determined SPC metrics establish the service delivery capability through SPC analysis of the past performance over a period of time (e.g. weekly, monthly).

Processing proceeds to step S256, where distribution module 356 identifies the performance distribution based on the received input data. While steps S254 and S256 are shown as parallel steps, these steps may be performed in series or as staggered events overlapping in time and may be performed in any desired order. For example, step S254 may be performed before step S256. Determining the performance distribution is an independent calculation where the input data is used to establish the performance distribution (commonly log normal, Poisson, or binomial).

Processing proceeds to step S258, where simulation module 358 creates a simulation model based on the determined SPC metrics (step S254) and the performance distribution (S256). The results of the performance distribution are used to build a Monte Carlo simulation to compute expected breaches for SLA targets for the process control range and customer requirement. In addition, the Monte Carlo simulation computes the expected loss for the service provider. Where there is lack of input data for determining a risk, the rule of three, a commonly used statistics rule, could be used for determining the associated risk.

Processing proceeds to step S260, where risk module 360 evaluates the risk of incurring a penalty. In this example, the tolerable risk of penalty is directed by corporate policy. Alternatively, the level of risk acceptable to the service provider is a matter of choice that may lie with the representative, or the application programmer. Some embodiments of the present invention report the risk of penalty to a user, who accepts or rejects the risk of penalty.

Processing proceeds to step S262, where risk module 360 produces modification data for adjustment of the simulation model. When the penalty risk presented in step S260 is not acceptable, or otherwise is rejected, the risk module provides data to simulation module 358 for re-running the simulation. In this embodiment, the user rejecting the penalty risk inputs change criteria for making a simulation model adjustment. One example of a change criteria is where the technical solution is adjusted and/or improved to provide a lower probability of failure. In that way, the penalty risk inputs reflecting the lower probability of failure are applied to the simulation model.

Processing proceeds to step S264, where recommendation module 364 recommends a service level agreement according to the acceptable penalty risk. In this example, the recommended SLA is reported to the user for negotiating with the client. Alternatively, the recommendation module operates to notify the client of the recommended SLA. Alternatively, the report to the client initiates and/or finalizes an SLA negotiation phase.

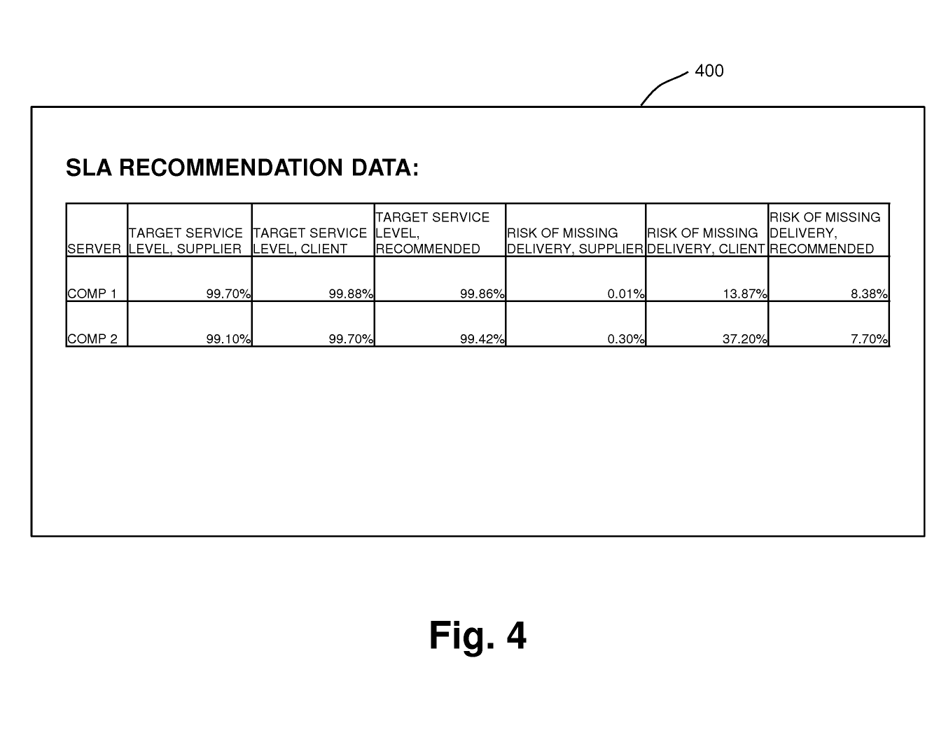

FIG. 4 is an illustration of screenshot 400 showing output according to some embodiments of the present invention. Server availability is the service being considered for servers “Comp 1” and “Comp 2.” The service provider, supplier, and the client each have a preferred target service level. The risk of missing each target for each server in question is determined according to an embodiment of the present invention and presented in screenshot 400.

As described at length above, a recommended service level and a corresponding risk of missing delivery of the service level is computed, according to an embodiment of the present invention. The recommended service level is reported in the screenshot along with the computed risk of missing the recommended service level.

Some embodiments of the present invention may include one, or more, of the following features, characteristics and/or advantages: (i) the automated SLA risk system calculates the likelihood of missing the SLA; (ii) it predicts the expected penalty payment over a given performance period; (iii) the method allows for the trade-off of supplier/consumer performance risk; (iv) performance distribution is identified; (v) simulation of process performance prior to operations; (vi) measure capability with statistical process control; (vii) analyzes past performance data to establish a service level that balances the service delivery capability with the needs of the client; (viii) analyzes past performance data to assess the risk of missing the target service level for a range of possible service level values; (ix) provides quantitative risk assessment based on past performance and clear assumptions to assess the likelihood that a service delivery team can meet the client objectives in the current environment; and/or (x) allows the target service level to be set and improved over time as the environment changes.

### III. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for determining a service level agreement (SLA) recommendation, the method comprising:
identifying a process capability by applying a statistical process control method to a past performance dataset;
identifying a statistical distribution according to the past performance dataset;
running a simulation model to determine a risk of missing a service level target based, at least in part, on the process capability and the statistical distribution; and
recommending an SLA based, at least in part, on the risk of missing the service level target.

2. The method of claim 1, wherein the step of determining a risk of missing a service level target includes calculating an expected penalty for a performance period.

3. The method of claim 1, wherein missing the service level target results in a penalty payment to a client.

4. The method of claim 1, wherein the SLA defines the level of performance committed to a client.

5. The method of claim 1, wherein the simulation model applies a Monte Carlo method.

6. The method of claim 1, further comprising:
comparing the risk of missing a service level target with a specified risk; and
responsive to the risk of missing a service level target being greater than the specified risk, applying change data to the simulation model.

7. A computer system for determining a service level agreement (SLA) recommendation, the computer system comprising:
a processor(s) set; and
a computer readable storage medium;
wherein:
the processor(s) set is structured, located, connected, and/or programmed to run program instructions stored on the computer readable storage medium; and
the program instructions include:
first program instructions programmed to identify a process capability by applying a statistical process control method to a past performance dataset;
second program instructions programmed to identify a statistical distribution according to the past performance dataset;
third program instructions programmed to run a simulation model to determine a risk of missing a service level target based, at least in part, on the process capability and the statistical distribution; and
fourth program instructions programmed to recommend an SLA based, at least in part, on the risk of missing the service level target.

8. The computer system of claim 7, wherein the step of determining a risk of missing a service level target includes calculating an expected penalty for a performance period.

9. The computer system of claim 7, wherein missing the service level target results in a penalty payment to a client.

10. The computer system of claim 7, wherein the SLA defines the level of performance committed to a client.

11. The computer system of claim 7, wherein the simulation model applies a Monte Carlo method.

12. The computer system of claim 7, further comprising:
comparing the risk of missing a service level target with a specified risk; and
responsive to the risk of missing a service level target being greater than the specified risk, applying change data to the simulation model.

13. A computer program product for determining a service level agreement (SLA) recommendation, the computer program product comprising a computer readable storage medium having stored thereon:
first program instructions programmed to identify a process capability by applying a statistical process control method to a past performance dataset;
second program instructions programmed to identify a statistical distribution according to the past performance dataset;
third program instructions programmed to run a simulation model to determine a risk of missing a service level target based, at least in part, on the process capability and the statistical distribution; and
fourth program instructions programmed to recommend an SLA based, at least in part, on the risk of missing the service level target.

14. The computer program product of claim 13, wherein the step of determining a risk of missing a service level target includes calculating an expected penalty for a performance period.

15. The computer program product of claim 13, wherein missing the service level target results in a penalty payment to a client.

16. The computer program product of claim 13, wherein the SLA defines a level of performance committed to a client.

17. The computer program product of claim 13, wherein the simulation model applies a Monte Carlo method.

18. The computer program product of claim 13, further comprising:
comparing the risk of missing a service level target with a specified risk; and
responsive to the risk of missing a service level target being greater than the specified risk, applying change data to the simulation model.
